(19) United States
(12) Patent Application Publication
(10) Pub. No.: US 2021/0035024 A1
(43) Pub. Date: Feb. 4, 2021

(54) EFFICIENT METHOD FOR SEMI-SUPERVISED MACHINE LEARNING

(71) Applicant: Visa International Service Association, San Francisco, CA (US)

(72) Inventors: Hao Yang, San Jose, CA (US); Jonathan Tuck, Palo Alto, CA (US)

(21) Appl. No.: 16/966,650

(22) PCT Filed: Feb. 2, 2018
(86) PCT No.: PCT/US2018/016704

§ 371 Date: Jul. 31, 2020

(51) Int. Cl. G06N 20/10; G06N 5/04

(52) U.S. Cl. CPC G06N 20/10; G06N 5/04

(57) ABSTRACT

A method is disclosed. The method includes a) obtaining a data set comprising a subset of labeled data and a subset of unlabeled data, b) determining a minimization equation characterizing a semi-supervised learning process, the minimization equation comprising a convex component and a non-convex component; c) applying a smoothing function to the minimization equation to obtain a smoothed minimization equation; d) determining a surrogate function based on the smoothed minimization equation and the data set, wherein the surrogate function includes a convex surrogate function component and a non-convex surrogate function component; e) performing a minimization process on the surrogate function resulting in a temporary minimum solution; and f) repeating d) and e) until a global minimum solution is determined. The method also includes creating a support vector machine using the global minimum solution.

### CROSS-REFERENCES TO RELATED APPLICATIONS

None.

### BACKGROUND

Classification, one of the most important tasks in machine learning, relies on an abundance of labeled data. In addition, there are many machine learning techniques to perform classification, the most well-studied of which is support vector machines (SVMs) which seeks to find a classifier that maximizes a margin between classes in a labeled data set [Trevor Hastie, Robert Tibshirani, and Jerome Friedman. The Elements of Statistical Learning. Springer Series in Statistics. Springer New York Inc., New York, N.Y., USA, 2001]. In many real-world applications, however, labeled data is scarce and unlabeled data is abundant. Due to the ever-increasing need for algorithms that require less labeled data pairs, semi-supervised learning, which studies the ability to construct classification models with both labeled and unlabeled data [Olivier Chapelle, Bernhard Schlkopf, and Alexander Zien. Semi-Supervised Learning. The MIT Press, 1st edition, 2010], has recently seen a resurgence in research [Tomoya Sakai, Marthinus Christoffel du Plessis, Gang Niu, and Masashi Sugiyama. Semi-supervised classification based on classification from positive and unlabeled data. In Proceedings of the 34th International Conference on Machine Learning, volume 70 of Proceedings of Machine Learning Research, pages 2998-3006, International Convention Centre, Sydney, Australia, 06-11 Aug. 2017] [Xiaolan Liu, Tengjiao Guo, Lifang He, and Xiaowei Yang. A low-rank approximation-based transductive support tensor machine for semisupervised classification. IEEE Transactions on Image Processing, 24(6):1825-1838, June 2015].

Semi-supervised support vector machines (S3VMs) are a method of extending the SVM framework to handling both labeled and unlabeled data [Kristin P. Bennett and Ayhan Demiriz. Semi-supervised support vector machines. In Proceedings of the 1998 Conference on Advances in Neural Information Processing Systems II, pages 368-374, Cambridge, Mass., USA, 1999. MIT Press]. Intuitively, one might interpret solving an S3VM problem as solving a standard SVM with a regularizer that incorporates the unlabeled data. Unfortunately, a direct formulation of the S3VM problem is non-convex and is not readily scalable to large datasets [Ronan Collobert, Fabian Sinz, Jason Weston, and Leon Bottou. Large scale transductive svms. Journal of Machine Learning Research, 7:1687-1712, December 2006]. There have been a number of algorithms introduced to solve the semi-supervised SVM problem. However, these algorithms have extremely long computation times, and are therefore not effective.

Embodiments of the invention address these and other problems individually and collectively.

### BRIEF SUMMARY

Embodiments of the invention are directed to methods and systems for performing an efficient method for semi-supervised machine learning.

One embodiment of the invention is directed to a method comprising: a) obtaining, by a computing device; a data set comprising a subset of labeled data and a subset of unlabeled data; b) determining, by the computing device, a minimization equation characterizing a semi-supervised learning process, the minimization equation comprising a convex component and a non-convex component; c) applying, by the computing device, a smoothing function to the minimization equation to obtain a smoothed minimization equation; d) determining, by the computing device, a surrogate function based on the smoothed minimization equation and the data set, wherein the surrogate function includes a convex surrogate function component and a non-convex surrogate function component; e) performing a minimization process, by the computing device, on the surrogate function resulting in a temporary minimum solution; f) repeating d) and e) until a global minimum solution is determined, the global minimum solution representing a maximum width between support vectors in a support vector machine; and g) creating, by the computing device, a support vector machine using the global minimum solution.

Another embodiment of the invention is directed to a computing device configured or programed to perform the above-noted method.

Further details regarding embodiments of the invention can be found in the Detailed Description and the Figures.

### BRIEF DESCRIPTION OF THE DRAWINGS

FIG. 1 shows two graphs depicting example data and possible hyperplanes,

FIG. 2 show graphs depicting a convex-concave procedure.

FIG. 3 shows a system according to an embodiment of the invention.

FIG. 4 shows a high-level diagram depicting a general method for training and using a machine learning model.

FIG. 5 shows a flow diagram depicting a method according to an embodiment of the invention.

FIG. 6 shows a graph of a smoothing function.

FIG. 7A shows a first example of majorizing an equation with a surrogate function.

FIG. 7B shows a second example of majorizing an equation with a surrogate function.

FIG. 8 shows a graph of optimization time versus a number of unlabeled samples.

FIG. 9 shows a graph of optimization time versus a number of dimensions.

### DETAILED DESCRIPTION

Prior to discussing embodiments of the invention, some terms can be described in further detail.

The term “server computer” may include a powerful computer or cluster of computers. For example, the server computer can be a large mainframe, a minicomputer cluster, or a group of computers functioning as a unit. In one example, the server computer may be a database server. The server computer may be coupled to a database and may include any hardware, software, other logic, or combination of the preceding for servicing the requests from one or more other computers.

A “machine learning model” can refer to a set of software routines and parameters that can predict an output(s) of a real-world process (e.g., a diagnosis or treatment of a patient, identification of an attacker of a computer network, identification of fraud in a transaction, a suitable recommendation based on a user search query, etc.) based on a set of input features. A structure of the software routines (e.g., number of subroutines and relation between them) and/or the values of the parameters can be determined in a training process, which can use actual results of the real-world process that is being modeled.

A “computing device” can refer to any suitable device that is used in executing a machine learning model.

A “hyperplane” may be a subspace of one dimension less than its ambient space. For example, if the ambient space is 3-dimensional, then the corresponding hyperplanes are 2-dimensional planes. A hyperplane may refer to a n-dimensional plane that best separates a number of data points.

A “surrogate function” may refer to any function which acts as a proxy for another function.

A “support vector machine” or “SVM” may be a machine learning model with associated learning algorithms that analyze data used for classification and regression analysis.

“Optimization” may refer to a selection of a best element, with regard to some criteria, from some set of available alternatives.

A “processor” may refer to any suitable data computation device or devices. A processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical; optical; and/or magnetic mode of operation.

In order to facilitate understanding of the present invention; introduced hereinafter is a brief introduction to support vector machines (SVMs) using only labeled data.

SVMs may belong to a category of maximum-margin classifiers, and they may perform binary classification (i.e.; they may have two output classes), by finding, in a feature space of the SVM, a decision hypersurface (usually referred to as a hyperplane) that splits positive examples from negative examples. The positive examples and the negative examples are included in training data. The split may be one that has a largest distance from the hyperplane to a nearest of the positive examples and the negative examples. The nearest of the positive examples and the negative examples may be support vectors, generally making the classification correct for testing data that is similar, but not identical, to the training data. SVMs can be applied to regression, classification, density estimation problems, etc.

Focusing on classification, SVMs may receive labeled training data L={(xᵢ,yᵢ)}ᵢ₌₁^{L} which may describe a learning task as input, wherein xᵢ are vectors representing the input data to be classified (observations), and wherein yᵢ are class labels, typically in a set {−1, +1}.

In their basic form, SVMs may learn linear decision rules through the following decision function:

$$h ( x ) = \{ \begin{matrix}sign ( w \cdot x + b ) & if w \cdot x + b \geq 0 \\ - 1 & otherwise\end{matrix}$$

The decision function, also known as a hypothesis, is described by a weight vector w and a threshold, or bias, b. Depending on which side of the hyperplane an input vector x lies on, it may be classified into class +1 or −1. With SVMs, a goal can be finding the hyperplane with a largest margin for separable data. In other words, for separable training sets, SVMs may find the hyperplane, which separates positive training data points and negative training data points, marked with “+” and “−” respectively, with the largest margin. Training data points closest to the hyperplane may be support vectors. The hyperplane may relate to a minimum solution, preferably a global minimum solution, to an optimization problem. The global minimum solution may represent a maximum width between support vectors in a support vector machine.

Computing the hyperplane may be similar to solving a quadratic optimization problem. In the SVM case, for solving the quadratic optimization problem as well as applying the learned decision rule, it can be sufficient to calculate inner products between observation vectors. The use of kernel functions may be introduced for learning non-linear decision rules. Such kernel functions may calculate an inner product in a high-dimensional feature space. Popular kernel functions may be linear, polynomial, radial basis function (RBF), and sigmoid. Therefore, depending on the type of the kernel function, SVMs can be linear classifiers, polynomial classifiers, radial basis function (RBF) classifiers, two-layer sigmoid neural networks, etc.

Classification on SVMs, as well as more advanced semi-supervised support vector machines (S3VM), can be difficult to implement efficiently. Embodiments of the invention introduce a method of solving the S3VM problem using a majorization-minimization (MM) algorithmic framework, which may be referred to as MM-S3VM. A method of solving the S3VM problem with the MM-S3VM may allow for a simple solution by at least upper-bounding an objective function by a quadratic and minimizing the quadratic at every iteration. Embodiments of the invention outline the MM-S3VM, using a quadratic majorizer. The MM-S3VM's performance may be compared to both the SVM problem and to the S3VM problem solved with various techniques.

The following section is a review of methods to perform classification with the SVM problem as well as several methods for solving the S3VM problem.

### 1 Problem Statement

1.1 Standard (Supervised) SVM Problem

The SVM problem tries to determine a classifier for data, such that a margin between at least two classifications of the data is maximized. A set of data that is used may be training data, wherein the training data is given as L labeled example pairs {(xᵢ, yᵢ)}ᵢ₌₁^{L}, wherein each xᵢ∈Rⁿ (xᵢ is a member of Real numbers of dimension n) is a feature vector, and wherein each yᵢε{−1,1} is an associated class for xᵢ. In this case, the associated class, yᵢ, may be either −1 or 1. yᵢ=−1 may relate to a first class, whereas yᵢ=1 may relate to a second class. For example, yᵢ=−1 may represent “no fraud” and yᵢ=1 may represent “fraud.” The SVM may only use labeled training data; the SVM does not use unlabeled data.

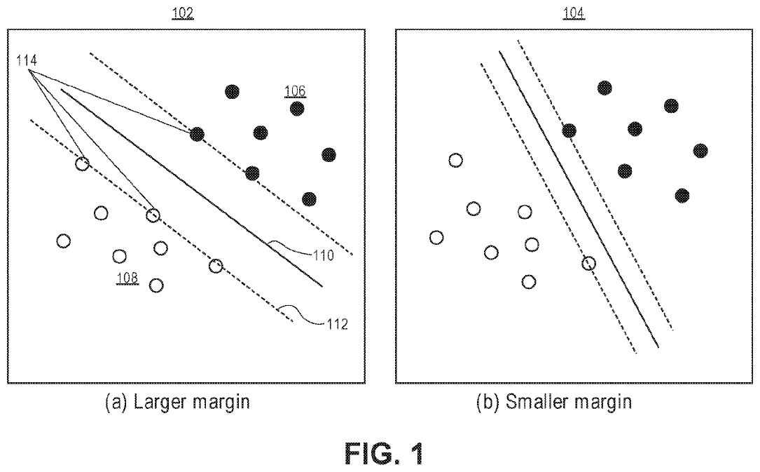

FIG. 1 shows two graphs depicting example data and possible hyperplanes. Graph (a) 102 shows a larger margin, whereas graph (b) 104 shows a smaller margin. Graph (a) 102 includes black data points 106, white data points 108, a hyperplane 110, a margin line 112, and support vectors 114.

The black data points 106 may represent labeled data comprising at least an associated class, yᵢ, such as a −1 or a 1. The class of the black data points 106 may be any suitable classification assigned to the data, such as, for example cancer indication, fraud indication, transaction data, color, etc. The white data points 108 may represent labeled data comprising at least an associated class, yᵢ, such as a −1 or a 1. For example, the black data points 106 may be assigned the classification of “no fraud” and yᵢ=−1, while the white data points 108 may be assigned the classification of “fraud” and yᵢ=1.

Hyperplane 110 may be a line that best separates the black data points 106 and the white data points 108. The hyperplane 110, in general, may be a subspace of one dimension less than its ambient space. For example, in graph (a) 102 the ambient space has two dimensions and the hyperplane 110 has one dimension. The hyperplane 110 may be defined by an equation and/or values. For example, the hyperplane 110 may be defined by weights and a bias.

The margin line 112 may be parallel to the hyperplane 110 and may have the same dimensionality as the hyperplane 110. For example, if the hyperplane 110 has eight dimensions, then the margin line 112 may also have eight dimensions. In the example of graph (a) 102, both the hyperplane 110 and the margin line 112 are one dimensional. The margin line 112 may be located on both sides of the hyperplane 110 and equidistant from the hyperplane 110. The distance between two margin lines may be a margin.

In some embodiments, the margin line 112 may allow fora hard margin. Hard margins may be used when the training data is linearly separable. Hard margins may result in the fitting of a model that allows zero errors, meaning no data points or support vectors 114 are located between the margin line 112 and the hyperplane 110.

In other embodiments, the margin line 112 may allow for a soft margin. Soft margins may be used when the training data is not linearly separable. Soft margins may allow for some of the data points or support vectors to be within the margin.

The support vectors 114 may be data points closest to the hyperplane 110. The margin line 112 may pass through and/or near the support vectors 114. The support vectors 114 may be used to determine a largest margin possible, also referred to as a maximum margin or an optimal margin.

Graph (b) 104 shows a smaller margin compared to the margin in graph (a) 102. The smaller margin in graph (b) 104 may correspond to a hyperplane which is not a best fit hyperplane for the data. Meaning, the smaller margin is not the optimal margin.

The standard SVM finds β∈R″ and v∈R that correspond to a classifier sign{β^{T}Φ{x}−v}=sign{(β,ν)^{T}(Φ{x}, 1)} that maximizes the margin, wherein β represents weights and ν represents a bias, and wherein the weights and the bias define the hyperplane. For example, β^{T}Φ{x}−ν may represent the hyperplane. The values of β and ν that yield an optimal classifier may be determined by a solution to the following convex optimization equation:

$$minimize {\sum }_{i = 1}^{L} {( 1 - {y}_{i} ( {β}^{T} Φ \{ {x}_{i} \} - v ) )}_{+} + \frac{λ}{2} {‖ β ‖}_{2}^{2} \qquad ( 1 )$$

where β and ν may be optimization variables, λ may be a hyperparameter, and (x)₊≡max{0,x}. The hyperparameter may be a value. In some embodiments, the hyperparameter may be modified so that the model can optimally solve the machine learning problem. An optimal hyperparameter may be determined by a computing device to yield an optimal model which minimizes a loss function. In some embodiments, the hyperparameter may be a regularizer. The regularizer may be used in a process of regularization.

In general, φ: Rⁿ→Rⁿ is a nonlinear function through which a solution to equation (1) could be extended to non-linear classifiers via the kernel trick [Thomas Hofmann, Bernhard Schlkopf, and Alexander J. Smola, Kernel methods in machine learning, 2008]. However, for simplicity, the following equations consider the case where Φ{x}=x (i.e., the argument of the classifier is affine in x) and continue analysis from that assumption. In some embodiments of the invention, the training data may not be linearly separable and the kernel trick may be used to transform the nonlinear function into a linear function.

1.2 Semi-Supervised Support Vector Machine (S3VM) Problem

S3VMs (sometimes referred to as transductive SVMs, or TSVMs) are extensions of SVMs to incorporate unlabeled data. This problem considers labeled training data as described in the SVM problem as well as unlabeled training data {(xᵢ)}_{i=L+1}^{U}. The classifier from equation (1) may assign the label sign {ƒ(xᵢ)} to unlabeled xᵢ. sign {ƒ(xᵢ)} may be equal to yᵢ. Next, a loss function may be determined for the unlabeled training data. In general, a loss function may be a function that maps an event or values to one or more variables onto a real number intuitively representing some “cost” associated with the event or values. In this case, the loss function may be a hinge loss. The hinge loss may be a loss function used for training classifiers. The hinge loss of the unlabeled points may be:

$${\sum }_{i = L + 1}^{U} {( 1 - {y}_{i} f ( {x}_{i} ) )}_{+}$$

The hinge loss may be simplified. Since

sign{ƒ(x)}ƒ(x)=|ƒ(x)|,

the total hinge loss on the unlabeled points is then

$${\sum }_{i = L = 1}^{U} {( 1 - {y}_{i} f ( {x}_{i} ) )}_{+} = {\sum }_{i = L + 1}^{U} {( 1 - \vert f ( {x}_{i} ) \vert )}_{+}$$

$$i = L + 1 , … , U$$

Therefore, due to the hinge loss and equation (1), the S3VM may determine a function ƒ(x)=β^{T}x−ν that solves

$$minimize {\sum }_{i = 1}^{L} {( 1 - {y}_{i} ( {β}^{T} {x}_{i} - v ) )}_{+} + \frac{{λ}_{1}}{2} {‖ β ‖}_{2}^{2} + {λ}_{2} {\sum }_{i = L + 1}^{U} {( 1 - \vert ( {β}^{T} {x}_{i} - v ) \vert )}_{+} \qquad ( 2 )$$

where βεRⁿ and νεR may be the optimization variables, and λ₁ and λ₂ may be hyperparameters. The third term in equation (2) makes the entirety of equation (2) non-convex in (β,ν).

Due to the non-convexity of equation (2), equation (2) needs to be solved either by global optimization methods, which do not scale well with large data sets; or advanced heuristics which usually scale well, but may determine a minimum solution that is not a global minimum solution.

### 2 Current Approaches

This section is a literary review of previous methods to solve the S3VM problem. ∇S3VM and convex-concave procedure (COOP), as described in sections 2.1 and 2.2 below, attempt to determine a global minimum solution.

2.1 ∇S3VM

In a ∇S3VM, the S3VM problem may be made into a standard unconstrained optimization problem by approximating a hat loss (e.g., (1−|x|)₊) by a smooth approximation. The hat loss may be a loss function used in the ∇S3VM. The hat loss may be approximated by

(1−|x|)₊=exp(−sx²)

Popular choices for s in the literature include at least s=3 and s=5 [Ronan Collobert, Fabian Sinz, Jason Weston, and Leon Bottou. Large scale transductive svms. Journal of Machine Learning Research, 7:1687-1712, December 2006] [Olivier Chapelle, Vikas Sindhwani, and Sathiya S. Keerthi, Optimization techniques for semi-supervised support vector machines. Journal of Machine Learning Research, 9:203-233, June 2008]. The ∇S3VM problem then becomes

$$minimize {\sum }_{i = 1}^{L} {( 1 - {y}_{i} ( {β}^{T} {x}_{i} - v ) )}_{+}^{2} + \frac{{λ}_{1}}{2} {‖ β ‖}_{2}^{2} + {λ}_{2} {\sum }_{i = L = 1}^{U} exp ( - {s ( {β}^{T} {x}_{i} - v )}^{2} ) \qquad ( 3 )$$

where the optimization variables may be β and ν. The non-convex term in the objective is now smooth, but still is non-convex. Many different methods exist for solving this approximation, for example, by gradient descent. The ∇S3VM has an overall worst-case complexity of O(U³), meaning complexity on the order of unlabeled data cubed, and is thus not feasible for large data sets [Olivier Chapelle and Alexander Zien. Semi-supervised classification by low density separation, 2005] [Ronan Collobert, Fabian Sinz, Jason Weston, and Leon Bottou, Large scale transductive svms, Journal of Machine Learning Research, 7:1687-1712, December 2006], The computational complexity of the ∇S3VM directly increases the computation time of the process. Since the computational complexity rises on the order of (U)³ a large number of unlabeled data points will cause the process to have a long computation time. This is not efficient for a large number of unlabeled data points. For example, doubling the number of unlabeled data points will cause the computation time to be eight times longer.

2.2 Convex-Concave Procedure (CCCP)

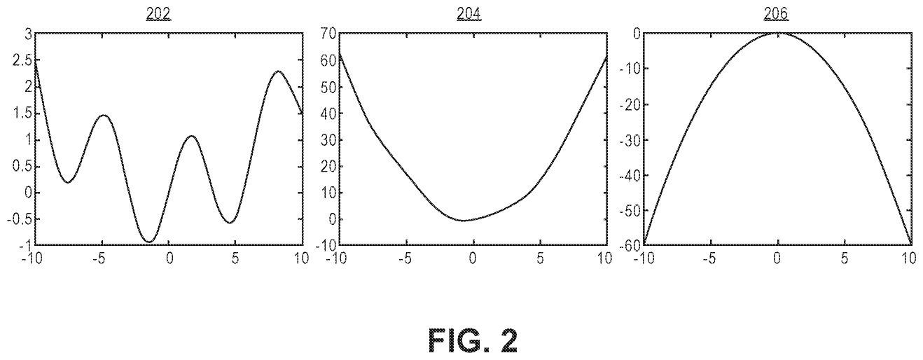

In COOP, the objective ƒ is split into a sum of two components, a convex term ƒᵥₑₓ and a concave term ƒ_{cave}. FIG. 2 shows a high-level diagram depicting a convex-concave procedure. The figure includes an objective ƒ 202, a convex term 204, and a concave term 206.

The objective ƒ 202 may be any function that is neither convex nor concave over its entire domain. An example of a function that is neither convex nor concave over its entire domain may be ƒ(x)=x³. The objective ƒ 202 may be split into the sum of two components, a convex term 204, ƒᵥₑₓ, and a concave term 206, ƒ_{cave}.

The convex term 204 may be any convex function. An example of a convex function may be ƒ(x)=x². The concave term 206 may be any concave function and may be referred to as a non-convex term. An example of a concave function may be ƒ(x)=−x². The objective ƒ 202 may be related to a combination of the convex term 204 and the concave term 206.

The CCCP may upper bound the concave term 206 with a line, and may iteratively minimize a sequence of convex functions [Alan L Yuille and Anand Rangarajan. The concave-convex procedure (cccp). In T. G. Dietterich, S. Becker, and Z. Ghahramani, editors, Advances in Neural Information Processing Systems 14, pages 1033-1040. MIT Press, 2002]. The COOP is detailed in Algorithm 1 below, wherein algorithm 1 may determine a minimum of the objective ƒ 202.

Algorithm 1 may represent a process for performing the CCCP. Although the steps in algorithm 1 are illustrated in a specific order, it is understood that algorithm 1 may include additional or fewer steps. In addition, algorithm 1 may use different syntax and/or functions than depicted.

```
Algorithm 1 Convex-Concave Procedure
Input: Input starting point x₀, tolerance ε > 0
  k = 0
  while ∇f(xₜ) > ε do
    xₖ₊₁ := arg min_{z} fᵥₑₓ(z) + ∇ f_{cave}(z − xₖ) + f_{cave}(xₖ)
    k := k + 1
  end while
```

Algorithm 1 may receive input comprising at least an input starting point x₀ and a tolerance ε. The input starting point x₀ may be a value or point for which algorithm 1 starts from. In some embodiments, the input starting point x₀ may be a random number.

The tolerance E may be greater than zero and may represent the smallest change allowed in a gradient of the objective ƒ 202. The tolerance ε may relate to a condition for ending Algorithm 1.

Next, a value k may be set to zero, wherein k may represent an iteration value and may be an integer.

Algorithm 1 may continue “while ∇ƒ(xᵢ)>ε.” In other words, while the gradient of the objective ƒ 202 of xₜ is greater than the tolerance ε, perform the subsequent steps.

Next, algorithm 1 may compute xₖ₊₁:=arg min_{z} ƒᵥₑₓ(z)+∇ƒ_{cave}(z−xₖ)+ƒ_{cave}(xₖ) In other words, compute the value of z for which the convex term ƒᵥₑₓ(z) plus the gradient of the concave term ƒ_{cave}(z−xₖ) plus the concave term ƒ_{cave}(xₖ) attains its minimum, wherein the value may be set equal to xₖ₊₁. This step may determine a minimum of the objective ƒ 202.

Next, algorithm 1 may compute k=k+1. For example, each time algorithm 1 iterates, the value of k may increase by 1.

As shown above, extending the use of the COOP to solve equation (2), referred to as CCCP-S3VM, may involve solving a series of convex optimization problems with one optimization variable in R^{2U-L}. As this is a dominant computation, the computational complexity of the CCCP-S3VM is O((2U−L)³), although in practice is typically O((2U−L)²) [Ronan Collobert, Fabian Sinz, Jason Weston, and Leon Bottou. Large scale transductive sums. Journal of Machine Learning Research, 7:1687-1712, December 2006], which is among the lowest computational complexities of the above discussed semi-supervised SVM algorithms [Xiaolan Liu, Tengjiao Guo, Lifang He, and Xiaowei Yang. A low-rank approximation-based transductive support tensor machine for semisupervised classification. IEEE Transactions on image Processing, 24(6):1825-1838, June 2015]. The computational complexity of the CCCP-S3VM directly increases the computation time of the process. Since the computational complexity rises on the order of (2U−L)², a large number of unlabeled data points, compared to labeled data points, will cause the process to have a long computation time. This is not efficient for a large number of unlabeled data points compared to labeled data points.

### 3 The Majorization-Minimization (MM) Algorithmic Framework

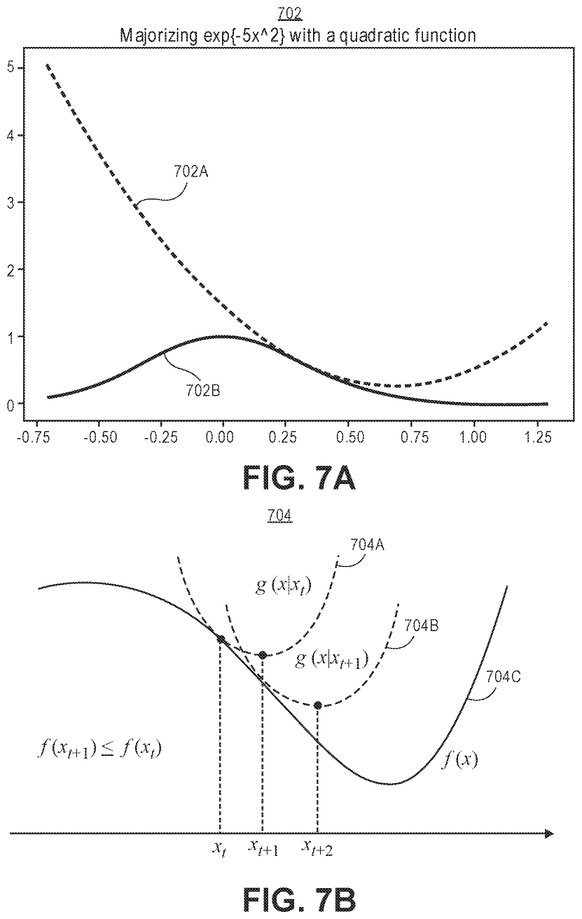

This section includes a brief overview of a framework that can be used in embodiments of the invention. The MM algorithmic framework may be applied to the S3VM; this may be MM-S3VM. This framework can use surrogate functions to identify minimum points on a particular function. A graphical illustration of an example of this type of process will be described below with respect to FIG. 7.

Consider the following optimization problem:

$$minimize h ( x ) \\ subject to x ∈ S , \qquad ( 4 )$$

where x may be an optimization variable, S may be a nonempty closed set in Rⁿ and h:S→R may be a continuous function. The MM algorithm minimizes h(x), at each iteration k with point xₖ, wherein minimizing may include finding a surrogate function that majorizes h at xₖ as well as minimizing the surrogate function. The surrogate function may be chosen such that it is easier to minimize than h(x) [David R. Hunter and Kenneth Lange. A tutorial on mm algorithms. The American Statistician, pages 30-37, 2004]. The surrogate function, g:S→R, to majorize h at xₖ, may satisfy the following two conditions:

$$g ( {x}_{k} ; {x}_{k} ) = h ( {x}_{k} ) \\ g ( x ; {x}_{k} ) \geq h ( x ) , ∀ x ∈ S \qquad ( 5 )$$

A general MM algorithm is summarized in algorithm 2, below. Algorithm 2 may represent a process for performing a general majorization-minimization algorithmic framework. Although the steps in algorithm 2 are illustrated in a specific order, it is understood that algorithm 2 may include additional or fewer steps. In addition, algorithm 2 may use different syntax and/or functions than depicted.

```
Algorithm 2 General Majorization-Minimization Algorithm
Input: x₀ ∈ S
  while not converged do
    Construct majorizing surrogate function g(x; xₖ) of h(x)
    xₖ₊₁ := argmin g(x; xₖ)
      x ∈ C
    k := k + 1
  end while
  return xₖ
```

Algorithm 2 may receive input comprising at least a value x₀, wherein x₀ is a member of the feasible set S. x₀ may be an initial starting point for the algorithm. In some embodiments, x₀ may be a random number.

Algorithm 2 may continue “while not converged,” wherein “not converged” may refer to a process of finding a minimum of h(x) having not yet converged. In other words, if the minimum of h(x) has not been determined, continue with the next step in algorithm 2.

Next, algorithm 2 may construct a surrogate function g(x; xₖ) to represent the function h(x). Construction of the surrogate function is described in detail in section 4.2.

Algorithm 2 may then compute a minimum of the surrogate function g(x; xₖ).

Next, algorithm 2 may compute k:=k+1, wherein k represents an iteration value and may be an integer. For example, each time algorithm 1 iterates, the value of k may increase by 1.

Algorithm 2 may end the “while” loop when the process of minimizing the surrogate function converges. In some embodiments, minimizing the surrogate function may converge based on a predetermined criteria, such as a tolerance.

The last step of algorithm 2 may return a value for xₖ. The value for xₖ may be a minimum of h(x), wherein the minimum of h(x) may be a global minimum solution. The global minimum solution may represent a maximum width between support vectors. The values of xₖ prior to the global minimum solution may be temporary minimum solutions.

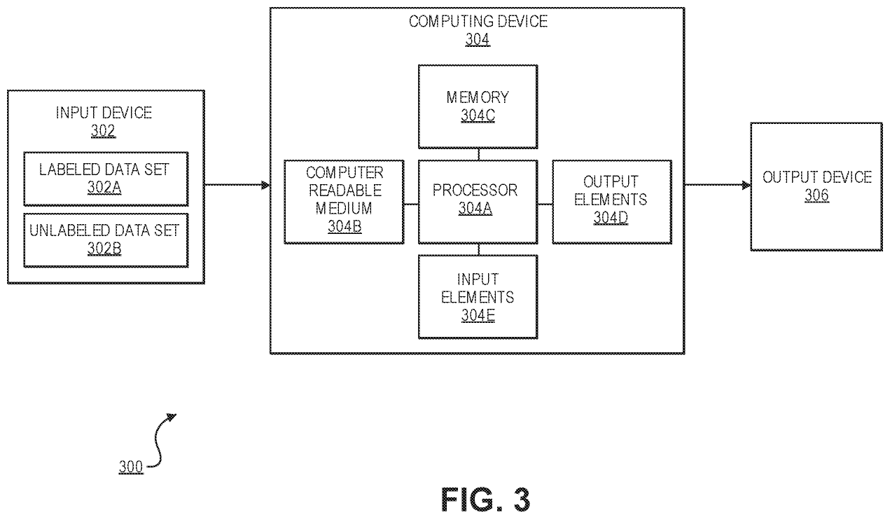

The majorization-minimization algorithmic framework may be implemented on physical devices. FIG. 3 shows a system according to an embodiment of the invention. System 300 may include an input device 302, a computing device 304, and an output device 306.

The input device 302 may be any device such as a computer that is capable of storing and transmitting data. The input device 302 may comprise a data processor and a database capable of storing a labeled data set 302A and an unlabeled data set 302B. The input device 302 may comprise a conventional, fault tolerant, relational, scalable, secure database such as those commercially available from Oracle™ or Sybase™. The input device 302 may be capable of transmitting the labeled data set 302A and/or the unlabeled data set 302B to the computing device 304. In some embodiments, the computing device 304 may be capable of obtaining the labeled data set 302A and/or the unlabeled data set 302B from the input device 302.

Data transferred from the input device 302 to the computing device 304 may be in the form of signals which may be electrical, electromagnetic, optical, or any other signal capable of being received by the computing device 304 (collectively referred to as “electronic signals” or “electronic messages”). These electronic messages that may comprise data or instructions may be provided between the input device 302 and the computing device via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The labeled data set 302A may contain any number of data points corresponding to training data that has been assigned to a class. The data points in the labeled data set 302A may have any number of features. In some embodiments the labeled data set 302A may include data with classes and features relating to fraud. For example, some data in the labeled data set 302A may be assigned to a first class, “fraud,” and others to a second class, “no fraud.” The features may relate to the class and, in this example, may correspond to fraud indicators such as “first time shopper,” “larger than normal transaction,” “transactions that include several of the same item,” “transaction amount,” “rush or overnight shipping,” etc.

The unlabeled data set 302B may contain any number of data points corresponding to training data that has not yet been assigned a class. The data in the unlabeled data set 302B may have any number of features. An example of a data point in the unlabeled data set 302B may be {first time shopper: “yes”; larger than normal transaction: “no”; transactions that include several of the same item: “yes”, 5; transaction amount: $532.21; rush or overnight shipping: “yes”}. A data point in the unlabeled data set 302B may be in any suitable format.

The computing device 304 may be any device capable of determining an output from an input. The computing device 304 may comprise a processor 304A, a computer readable medium 304B, a memory 3040, one or more output elements 304D, and one or more input elements 304E.

The computer readable medium 304B may comprise code, executable by the processor 304A, to implement a method comprising: a) obtaining, by a computing device, a data set comprising a subset of labeled data and a subset of unlabeled data; b) determining, by the computing device, a minimization equation characterizing a semi-supervised learning process, the minimization equation comprising a convex component and a non-convex component; c) applying, by the computing device, a smoothing function to the minimization equation to obtain a smoothed minimization equation; d) determining, by the computing device, a surrogate function based on the smoothed minimization equation and the data set, wherein the surrogate function includes a convex surrogate function component and a non-convex surrogate function component; e) performing a minimization process, by the computing device, on the surrogate function resulting in a temporary minimum solution; f) repeating d) and e) until a global minimum solution is determined, the global minimum solution representing a maximum width between support vectors in a support vector machine; and g) creating; by the computing device, a support vector machine using the global minimum solution.

The memory 3040 may store code, the labeled data set 302A, the unlabeled data set 302B, a model, and any other relevant data or functional code. The memory 304C may be in the form of a secure element, a hardware security module; or any other suitable form of secure data storage. The memory 3040 may be a memory device.

The one or more output elements 304D may comprise any suitable device(s) that may output data. Examples of output elements 304D may include display screens, speakers, and data transmission devices.

The one or more input elements 304E may include any suitable device(s) capable of inputting data into the computing device 304. Examples of input elements include buttons, touchscreens, touch pads, microphones, data receiver devices, etc.

The computing device 304 may be capable of receiving data from the input device 302. The received data may be the labeled data set 302A, the unlabeled data set 3028, or both data sets. The computing device 304 may be capable of determining a model based on the received data, and capable of transmitting the model to the output device 306. The model may be a support vector machine.

The output device 306 may be any device capable of receiving an output. The output device 306 may receive outputs from the computing device 304, such as a model. The output device 306 may be capable of using and/or performing operations on the model. For example, the computing device 304 may transmit a model to the output device 306. The output device 306 may then apply the model to other data sets.

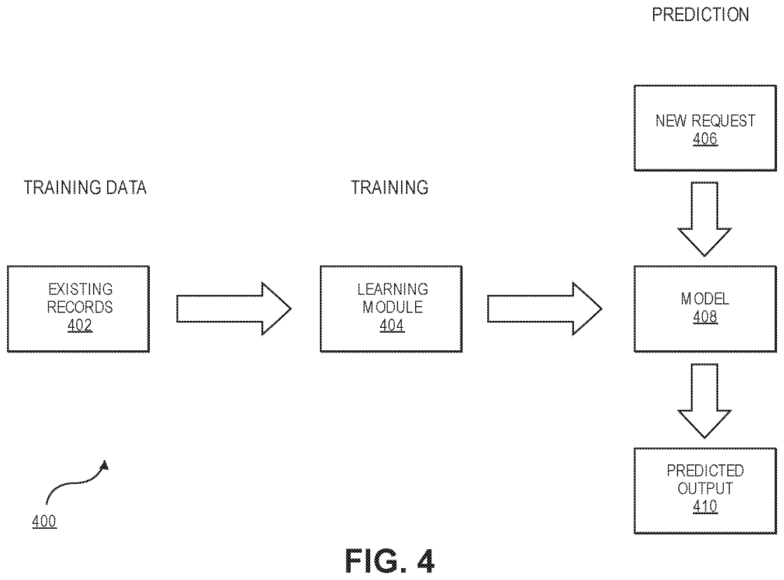

FIG. 4 shows a high-level diagram depicting a general method for training and using a machine learning model. Method 400 contains existing records 402, learning module 404, new request 406, model 408, and predicted output 410.

The existing records 402 may be stored on input device 302. The existing records 402 may be training data and may include the labeled data set 302A and the unlabeled data set 302B. For example, the existing records 402 may be fraud data, wherein the labeled data set 402A includes data associated with a class of either “fraud” or “no fraud,” and wherein the unlabeled data set 302B includes data that is not associated with a class. The input device 302 may be capable of transmitting the existing records 402 to the learning module 404, wherein the learning module 404 may be located on the computing device 304.

The learning module 404 may be a module capable of performing the MM-S3VM. After the learning module 404 receives the existing records 402, the learning module 404 may determine the model 408 based on the existing records 402. The model 408 may include information about a hyperplane which may be an optimal hyperplane that maximizes a margin in the existing records 402. For example, the hyperplane may best separate the classes of “fraud” and “no fraud” based on the features of “first time shopper,” “larger than normal transaction,” “transactions that include several of the same item,” “transaction amount,” “rush or overnight shipping,” etc. In some embodiments, the model 408 may be transmitted from the computing device 304 to a second device (not shown), wherein the second device may apply the model 408 to a new request 406. The second device may be the output device 306. In other embodiments, the model 408 may remain on the computing device 304, wherein the learning module 404 may apply the model 408 to the new request 406.

The new request 406 may be in the form of additional labeled and/or unlabeled training data. The new request 406 may include a request to apply the model 408 to the additional labeled and/or unlabeled training data, wherein applying the model 408 to the additional labeled and/or unlabeled training data may include determining classifiers for every data point in the additional unlabeled training data. For example, the model 408 may be used to determine if data points in the additional unlabeled training data in the new request 406 correspond to classes of “fraud” or “no fraud.” In some embodiments, the model 408 may be further trained based on additional labeled and/or unlabeled training data. Applying the model 408 to the new request 406 may result in a predicted output 410.

The predicted output 410 may include classifiers for every data point in the additional unlabeled training data and an updated model based on at least the additional labeled and/or unlabeled training data and the model 408. In some embodiments, the learning module 404 or the output device 306 may transform unlabeled training data into new labeled data to obtain the predicted output 410. The new labeled data may be included in the predicted output 410.

The following section explains how the learning module 404 on the computing device 304 may determine the model 408, using the MM-S3VM.

### 4 Majorization-Minimization for Semi-Supervised SVMs

The majorization-minimization algorithmic framework may be used to solve the semi-supervised SVM problem. [Ying Sun, Prabhu Babu, and Daniel P. Palomar. Majorization-minimization algorithms in signal processing, communications, and machine learning. IEEE Trans, Signal Processing, 65(3):794-816, 2017]. The MM algorithmic framework may solve the semi-supervised SVM problem by decomposing the process of solving a larger, non-convex problem, into solving a sequence of smaller convex problems.

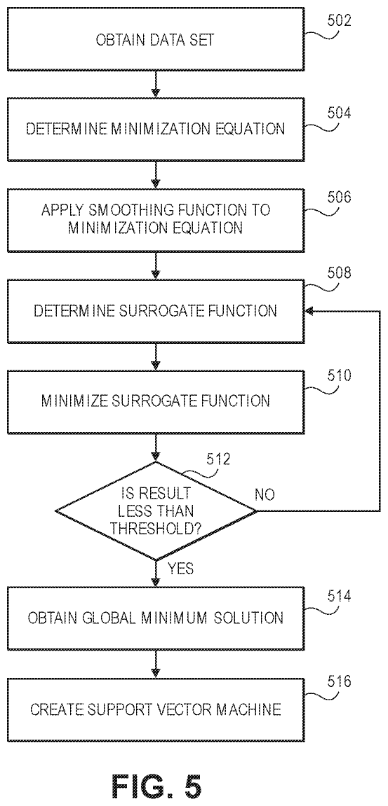

FIG. 5 shows a flow diagram depicting a method according to an embodiment of the invention. The method illustrated in FIG. 5 may be described in the context of classifying a fraud data set. It is understood, however, that the invention can be applied to other types of data and data analyses (e.g. disease screening, image recognition, transaction characterization, etc.). Although the steps are illustrated in a specific order, it is understood that embodiments of the invention may include methods that have the steps in different orders. In addition, steps may be omitted or added and may still be within embodiments of the invention.

At step 502, the computing device 304 may obtain a data set comprising a subset of labeled data and a subset of unlabeled data from the input device 302. The data set may be the existing records 402, the subset of labeled data may be the labeled data set 302A, and the subset of unlabeled data may be the unlabeled data set 302B. In some embodiments, the input device 302 may transmit the data set to the computing device 304. For example, the input device 302 may transmit a fraud data set comprising a subset of labeled data and a subset of unlabeled data, wherein data points in the labeled data are labeled as “fraud” or “no fraud.” The subset of labeled data and the subset of unlabeled data may correspond to any number of features. In some embodiments, for example, a feature may correspond to fraud indicators such as “first time shopper,” “larger than normal transaction,” “transactions that include several of the same item,” “transaction amount,” “rush or overnight shipping,” etc. In some embodiments, the data set may relate to transaction data, disease data, image data, facial recognition data, action recognition data, text data, or sound data.

In other embodiments, there may be more than two classes in the labeled data. For example, there may be the classes of “no fraud risk,” “low fraud risk,” “medium fraud risk,” “high fraud risk,” and “fraud.” Any number of classes may be used.

4.1 Smooth Approximation of Non-Convex Component

At step 504, after the computing device 304 has received the data set, the computing device 304 may determine a minimization equation characterizing a semi-supervised learning process, the minimization equation comprising a convex component and a non-convex component. Any suitable minimization equation may be used. For example, the minimization equation may be equation (6) below. Equation (2), discussed above, may be used to determine the minimization equation, equation (6).

Equation (2) is non-smooth, but there do exist smooth relaxations of equation (2). In particular, a smooth relaxation that has seen significant success in the literature [Olivier Chapelle, Vikas Sindhwani, and Sathiya S. Keerthi. Optimization techniques for semi-supervised support vector machines. Journal of Machine Learning Research, 9:203-233, June 2008], where the convex terms are kept identical to equation (2), but the non-convex terms are smoothed, may be of the form shown below:

$$minimize {\sum }_{i = 1}^{L} {( 1 - {y}_{i} ( {β}^{T} {x}_{i} ) )}_{+} + \frac{{λ}_{1}}{2} {‖ β ‖}_{2}^{2} + {λ}_{2} {\sum }_{i = L + 1}^{U} {( 1 - \vert ( {β}^{T} {x}_{i} - v ) \vert )}_{+}^{2} \qquad ( 6 )$$

where β∈Rⁿ and ν∈R may be the optimization variables, and λ₁ and λ₂ may be hyperparameters. In equation (6), the first two terms may be characterized as convex terms while the last term can be characterized as a non-convex term.

At step 506, after the computing device 304 has determined the minimization equation (e.g., equation (6)), the computing device 304 may apply a smoothing function to the minimization equation (e.g., equation (6)), to obtain a smoothed minimization equation. While any suitable smoothing function may be used, in some embodiments the smoothing function may be:

(1−|x|)₊²≈exp(−5x²),

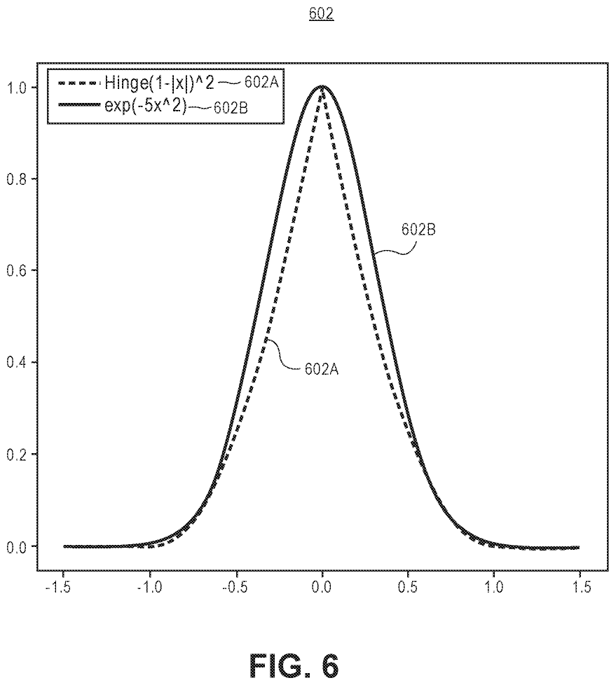

which has shown successful results in the semi-supervised setting [Olivier Chapelle and Alexander Zien. Semi-supervised classification by low density separation, 2005]. FIG. 6 shows a graph of a smoothing function. FIG. 6 shows a plot 602 of the smoothing function, a function 602A, and a smoothed function 602B.

The function 602A may be (1−|x|)₊², also referred to as Hinge(1−|x|)².

The smoothed function 602B may be exp(−5x²). The smoothed function 602B may be used to replace instances of the function 602A, in equation (6). The difference between the function 602A and the smoothed function 602B may be small, such that using the smoothed function 602B, rather than the function 602A, may not cause significant differences in a result.

Applying the smoothing function to the minimization equation results in a smoothed minimization equation:

$$minimize {\sum }_{i = 1}^{L} {( 1 - {y}_{i} ( {β}^{T} {x}_{i} - v ) )}_{+} + \frac{{λ}_{1}}{2} {‖ β ‖}_{2}^{2} + {λ}_{2} {\sum }_{i = L + 1}^{U} exp ( - 5 {\vert {β}^{T} {x}_{i} - v )}^{2} ) \qquad ( 7 )$$

where the optimization variables may be β and ν, and the hyperparameters may be λ₁ and λ₂, and problem data may be and (x₁, . . . , x_{U}) and (y₁, . . . , y_{L}) where L<U.

4.2 Determining a Surrogate Function

At step 508, after the computing device 304 has applied the smoothing function to the minimization equation, the computing device 304 may determine a surrogate function based on the smoothed minimization equation and the data set, wherein the surrogate function includes a convex surrogate function component and a non-convex surrogate function component. Determining the surrogate function for this problem may include finding the convex surrogate function component for the convex terms and finding the non-convex surrogate function for the non-convex terms. In some embodiments, the convex terms in equation (7) may be

$${\sum }_{i = 1}^{L} {( 1 - {y}_{i} ( {β}^{T} {x}_{i} - v ) )}_{+} + \frac{{λ}_{1}}{2} {‖ β ‖}_{2}^{2}$$

and the non-convex terms in equation (7) may be λ₂Σ_{i=L+1}^{U}exp(−5(β^{T}xᵢ−ν)²).

Finding an easily optimizable convex surrogate function component for the convex terms,

$${\sum }_{i = 1}^{L} {( 1 - {y}_{i} ( {β}^{T} {x}_{i} - v ) )}_{+} + \frac{{λ}_{1}}{2} {‖ β ‖}_{2}^{2} ,$$

can be done since the convex terms are already convex. Convex terms may be easily optimized over. The convex surrogate function component may be the convex terms,

$${\sum }_{i = 1}^{L} {( 1 - {y}_{i} ( {β}^{T} {x}_{i} - v ) )}_{+} + \frac{{λ}_{1}}{2} {‖ β ‖}_{2}^{2} .$$

The convex surrogate function component may be comprised of convex terms of the minimization equation.

To find the non-convex surrogate function component relating to the non-convex term, λ₂Σ_{i=L+1}^{U}exp(−5(β^{T}xᵢ−ν)²), θ may be parameterized as θ≡(β,ν)∈Rⁿ⁺¹, z may be parameterized as z≡(x, −1)∈Rⁿ⁺¹, and ƒ(θ) may be parameterized as ƒ(θ)=exp(−5(θ^{T}z)²). The non-convex surrogate function component may be determined by parameterizing non-convex terms of the minimization equation with a parameterization function, and applying a Taylor series expansion to the parameterization function. First, a Taylor expansion may be used to approximate ƒ(θ), wherein the Taylor expansion may be a representation of a function as an infinite sum of terms that are calculated from the values of the function's derivatives at a single point. Since ƒ:Rⁿ⁺¹→R is continuously differentiable with Lipschitz constant [symbol] =5, ƒ can be bound by a second-order Taylor expansion: namely, for all θ, θₖ∈Rⁿ⁺¹

$$f ( θ ) \leq f ( {θ}_{k} ) + ∇ {\{ f ( θ ) \}}^{T} {\vert}_{θ = {θ}_{k}} ( θ - {θ}_{k} ) + \frac{l}{2} {‖ θ - {θ}_{k} ‖}^{2} = exp ( - 5 {θ}_{k}^{T} z ) + ∇ {\{ exp ( - 5 {( {θ}^{T} z )}^{2} ) \}}^{T} {\vert}_{θ = {θ}_{k}} ( θ - {θ}_{k} ) + \frac{l}{2} {‖ θ - {θ}_{k} ‖}^{2} = exp ( - 5 {θ}_{k}^{T} z ) - 10 ( {θ}_{k}^{T} z ) exp ( {( - 5 {θ}_{k}^{T} z )}^{2} ) {z}^{T} ( θ - {θ}_{k} ) + \frac{l}{2} {‖ θ - {θ}_{k} ‖}^{2}$$

The following inequality may hold with equality at θ=θₖ:

$$exp ( - 5 {θ}^{T} z ) \leq exp ( - 5 {θ}_{k}^{T} z ) - 10 ( {θ}_{k}^{T} z ) exp ( - 5 {( {θ}_{k}^{T} z )}^{2} ) {z}^{T} ( θ - {θ}_{k} ) + \frac{l}{2} {‖ θ - {θ}_{k} ‖}^{2} \qquad ( 8 )$$

The non-convex surrogate function component may be determined using the above definitions of θ, z, and the Taylor expanded ƒ(θ) along with the non-convex term of the minimization equation. The non-convex surrogate function component may be:

$$\frac{{λ}_{2} l}{2} {‖ θ - {θ}_{k} ‖}^{2} + {λ}_{2} {\sum }_{i = L + 1}^{U} [ exp ( - 5 {( {θ}_{k}^{T} {z}_{i} )}^{2} ) - 10 ( {θ}_{k}^{T} {z}_{i} ) exp ( - 5 {( {θ}_{k}^{T} {z}_{i} )}^{2} ) {z}_{i}^{T} ( θ - {θ}_{k} ) ]$$

Majorization may be closed under addition and nonnegative multiplication. The objective of equation (7) may now be majorized. gₖ(θ) may be a majorizer of the objective of equation (7), and may be the surrogate function including the convex surrogate function component and the non-convex surrogate function component:

$$g ( θ ; {θ}_{k} ) = {\sum }_{i = 1}^{L} {( 1 - {y}_{i} {θ}^{T} {z}_{i} )}_{+} + \frac{{λ}_{1}}{2} {‖ {θ}_{1 : n} ‖}_{2}^{2} + \frac{{λ}_{2} l}{2} {‖ θ - {θ}_{k} ‖}^{2} + {λ}_{2} {\sum }_{i = L + 1}^{U} [ exp ( - 5 {( {θ}_{k}^{T} {z}_{i} )}^{2} ) - 10 ( {θ}_{k}^{T} {z}_{i} ) exp ( - 5 {( {θ}_{k}^{T} {z}_{i} )}^{2} ) {z}_{i}^{T} ( θ - {θ}_{k} ) ] \qquad ( 9 )$$

After the computing device 304 has determined the surrogate function, equation (9), based on the smoothed minimization problem and the data set, the flow diagram of FIG. 5 may proceed to step 510.

At step 510, the computing device 304 may perform a minimization process on the surrogate function resulting in a temporary minimum solution. The minimization process on the surrogate function may include at least minimizing the surrogate function. The minimization process may be performed efficiently by open-source convex optimization suites such as CVX [Michael Grant and Stephen Boyd. CVX: Matlab software for disciplined convex programming, version 2.1. http://cvxr.com/cvx, March 2014] or CVXPY [Steven Diamond and Stephen Boyd. CVXPY: A Python-embedded modeling language for convex optimization. Journal of Machine Learning Research, 17(83):1-5, 2016].

4.3 Convergence Criteria

A convergence criteria, also referred to as a threshold, may be used to determine if a temporary minimum solution is a global minimum solution. For a smooth unconstrained optimization problem, for example equation (7), a set of stationary points off may be defined as: [Ping Sun, Prabhu Babu, and Daniel P. Palomar. Majorization-minimization algorithms in signal processing, communications, and machine learning. IEEE Trans, Signal Processing, 65(3):794-816, 2017]

S⁺={x|∇ƒ(θ)=0} (9)

A convergence criteria may be determined in relation to the set S⁺. Convergence may be achieved with tolerance ε at iteration k if ∥θₖ₊₁−θₖ∥₂<ε. In other words, if the difference between two consecutively determined temporary minimum solutions is less than the tolerance ε at iteration k, then the global minimum solution has been determined.

At step 512, after the computing device 304 has performed the minimization process on the surrogate function, the computing device 304 may determine if a result of the minimization process on the surrogate function is less than a threshold, wherein the result may include two consecutively determined temporary minimum solutions. The computing device 304 may compare at least two temporary minimum solutions to determine if the global minimum solution is determined. In some embodiments, the threshold may be a value. In other embodiments, the threshold may be represented by ∥θₖ₊₁−θₖ∥₂<ε. If the threshold has not been met, the computing device 304 may repeat steps 508-512; the steps may be repeated until the global minimum solution is determined. Additionally, if the threshold has been met, the computing device 304 may proceed to step 514.

In some embodiments, the computing device 304 may repeat step 508, determining a surrogate function based on the smoothed minimization equation and the data set, wherein the surrogate function includes a convex surrogate function component and a non-convex surrogate function component, and step 510, performing a minimization process, by the computing device, on the surrogate function resulting in a temporary minimum solution, until a global minimum solution is determined.

At step 514, after convergence has been achieved, the global minimum solution may be determined. In some embodiments, the global minimum solution may be a most recently determined temporary minimum solution. The global minimum solution may represent a maximum width between support vectors in a support vector machine. The maximum width between support vectors may relate to an optimal hyperplane. For example, the optimal hyperplane may best separate a “fraud” class and a “no fraud” class.

FIG. 7A shows a first example of majorizing an equation with a surrogate function. This is a graphical depiction of steps 510-514. Graph 702 depicts majorizing a function exp(−5x²) 702B with a quadratic surrogate function 702A. The function exp(−5x²) 702B may, in this example, be a function that needs to be optimized, but is difficult to compute a minimum for. The quadratic surrogate function 702A may be constructed to easily determine a minimum for the function exp(−5x²) 702B. The quadratic surrogate function 702A may be any suitable quadratic function. The function exp(−5x²) 702B and the quadratic surrogate function may overlap at a single point. In other words, the function exp(−5x²) 702B and the quadratic surrogate function may be equal at a single point. The quadratic surrogate function 702A may be minimized to determine a minimum. A new quadratic surrogate function can then be constructed and minimized. This process may be repeated until a minimum of the function exp(−5x²) 702B is determined.

FIG. 7B shows a second example of majorizing an equation with a surrogate function. Graph 704 depicts a first surrogate function 704A and a second surrogate function 704B optimizing a generic function ƒ(x) 704C.

The generic function ƒ(x) 704C may be any non-convex function and may be a function that needs to be minimized. For example, the generic function ƒ(x) 704C may be exp(−5x²), or any other suitable function.

The first surrogate function 704A may be a quadratic function g(x) and may be constructed in order to equal the generic function ƒ(x) 704C at the point xₜ. In order to minimize the generic function ƒ(x) 7040, the first surrogate function 704A may be minimized. The minimum of the first surrogate function 704A may be xₜ₊₁ and satisfy the constraint of ƒ(xₜ₊₁)≤ƒ(xₜ). xₜ₊₁ may be a temporary minimum solution.

The second surrogate function 704B may then be constructed in order to equal the generic function ƒ(x) 704C at the point xₜ₊₁. The second surrogate function 704B may be minimized to determine the minimum point of xₜ₊₂. xₜ₊₂ may be a temporary minimum solution. This process of minimizing and constructing new surrogate functions may be performed until a minimum of an nth surrogate function is the same as, or a negligible distance to, the minimum of the generic function ƒ(x) 704C which may be the global minimum solution. For example, the nth surrogate function may be the fifth surrogate function or the six hundredth surrogate function depending on how many times the process of minimizing is performed.

At step 516, after the global minimum solution has been determined, the computing device 304 may create a support vector machine using the global minimum solution. In some embodiments, the support vector machine may be the model 408 that allows for the input of an additional unlabeled data set. The support vector machine may determine a classification for each data point in the additional unlabeled data set. For example, the additional unlabeled data set may include data corresponding to fraud indicators; the support vector machine may determine a classification of either “fraud” or “no fraud” for the data based on the corresponding fraud indicators.

In some embodiments, the computing device 304 may apply additional unlabeled data to the support vector machine, and may apply additional labeled data to the support vector machine.

In other embodiments, the support vector machine may allow for the input of an additional labeled data set. The support vector machine may use the additional labeled data set along with the data set, used previously, to determine an updated global minimum solution, and hence an updated support vector machine.

4.4 Outline of Algorithm

A general framework of using the MM algorithm is outlined in Algorithm 3, below. Algorithm 3 may represent a process for performing a semi-supervised support vector machine via majorization-minimization (MM-S3VM). Although the steps in algorithm 3 are illustrated in a specific order, it is understood that algorithm 3 may include additional or fewer steps. In addition, algorithm 3 may use different syntax and/or functions than depicted.

Algorithm 3 Semi-Supervised SVMs via Majorization-Minimization

```
Input: θ₀ = (β₀, v₀) ∈ Rⁿ⁺¹ by solving the standard SVM problem,
      equation (1)
  while True do
  Form surrogate function g(θ; θₖ)
  ${θ}_{k + 1} := ( {β}_{k + 1} , {ν}_{k + 1} ) := {arg min }_{θ ∈ C} g ( θ ; {θ}_{k} )$
  if ||θₖ₊₁− θₖ||₂ < ϵ then
    break
  end if
  k := k + 1
end while
return θₖ = (βₖ, vₖ).
```

Algorithm 3 may receive input comprising at least θ₀, wherein θ₀ may be a parameterization variable for β₀ and ν₀. θ₀ may be a member of Real numbers of dimension n+1.

Algorithm 3 may use a while loop when solving the semi-supervised SVM via majorization-minimization. The while loop may be used to repeat certain steps in the algorithm. Algorithm 3 may then form the surrogate function g(θ;θₖ) as described above. Next, algorithm 3 may compute the minimum of the surrogate function g(θ;θₖ). Algorithm 3 may then check if ∥θₖ₊₁−θₖ∥₂<ε, as described in step 512. Next, algorithm 3 may compute k:=k+1, wherein k may represent an iteration value and may be an integer. For example, each time algorithm 1 iterates, the value of k may increase by 1. Algorithm 3 may repeat the steps above until ∥θₖ₊₁−θₖ∥₂<ε. This may be done in the form of a “break” command. In some embodiments, the process may end when the while loop is no longer “True.”

Algorithm 3 may then return θₖ, wherein θₖ may be related to βₖ and νₖ. In some embodiments, θₖ may be the global minimum solution and may be used to determine a support vector machine.

4.5 Computational Complexity

Solving the S3VM problem with Algorithm 3 may involve solving a series of convex optimization problems with one optimization variable in Rⁿ. Solving the convex optimization problem is a dominating factor in computation time in Algorithm 3. The worst-case computational complexity of Algorithm 3 may be O(n³), which can be significantly faster than O(U³) or O((2U−L)²) as in previous methods. Many situations arise where the number of unlabeled data points, U, far exceeds the number of features, n; therefore making Algorithm 3 much more computationally efficient than previous methods.

### 5 Numerical Examples

Empirical results on an experiment using synthetic data are provided below in order to compare the efficiency of solving the MM-S3VM against the standard SVM (equation (1)), the ∇S3VM, and the CCCP-S3VM. All experiments described below were carried out on a MacBook Pro with a 2.90 GHz Intel® Core® i5 CPU.

5.1 Synthetic Problem Instance

For the experiment, synthetic data was first used to study the performance of the MM-S3VM against the standard SVM solution and against other S3VM solution methods. μεR and Σ∈S₊ⁿ were chosen, and ┌U/2┐ independent and identically distributed samples in Rⁿ from [symbol] (−μ1,Σ) and └U/2┘ independent and identically distributed samples in Rⁿ from [symbol] (−μ1,Σ) were randomly generated, with which the experiment's true classifier sign{βₜᵣᵤₑ^{T}x−νₜᵣᵤₑ}, with (βₜᵣᵤₑ,νₜᵣᵤₑ), [symbol] (0,I) was applied to achieve the true labels for the experiment.

First, a standard SVM was trained (i.e., solve equation (1)) with L=100, n=20μ=30, and Σ=25I. The number of unlabeled examples U−L between 100 and 5000 are varied and the difference between the standard SVM's test error and the test error of solving the MM-S3VM on a test set was determined. In addition, the same experiment while using the ∇S3VM and the CCCP algorithm was performed.

5.2 Experimental Datasets

A variety of different data sets were used to validate algorithm 3. Experiments were validated using synthetic Gaussian data, and datasets from both the LIBSVM database [Chih-Chung Chang and Chih-Jen Lin. LIBSVM: A library for support vector machines. ACM Transactions on Intelligent Systems and Technology, 2:27:1-27:27, 2011. Software available at http://www.csie.ntu.edu.tw/˜cjlin/libsvm] and the University of California, Irvine Machine Learning Repository [Moshe Lichman. University of California, Irvine machine learning repository. 2013].

5.3 Common Setup

In the experiment, in order to determine hyperparameters λ₁ and λ₂ that perform well on each dataset, a hyperparameter search over λ₁∈{2⁻¹⁰, . . . , 2¹⁰} and λ₂ε{0.01,1,100} was performed wherein ε=10⁻⁷ is fixed.

5.4 Numerical Results

In general, experimental results show that solving the S3VM problem with the MM-S3VM yields improvements over simply solving the standard SVM problem. The experiment was performed first using L=10 and then again using L=50. Table 1, below, shows test errors, over 60 trials with L=10, among a variety of different algorithms and data sets, wherein the highest performing test error per dataset is italicized and bolded. Table 2 shows average test errors, over 60 trials with L=50, among a variety of different algorithms and data sets, with a highest performing test error per dataset highlighted. The MM-S3VM yields the lowest average test error among the algorithms. However, the MM-S3VM did not attain the lowest test error on 3 datasets for L=10 (Table 1) and on 1 dataset for L=50 (Table 2).

TABLE 1

| | | Standard | | | |
|---|---|---|---|---|---|
| Dataset | n | SVM | ∇S3VM | CCCP-S3VM | MM-S3VM |
| Gaussian | 20 | 0.310 | 0.263 ± 0.010 | 0.261 ± 0.013 | [symbol] |
| Data | | | | | |
| splice | 60 | 0.231 | 0.216 ± 0.007 | 0.202 ± 0.006 | [symbol] |
| a1a | 123 | 0.265 | 0.262 ± 0.001 | [symbol] | 0.261 ± 0 |
| fourclass | 2 | 0.223 | 0.364 ± 0 | 0.271 ± 0.003 | [symbol] |
| ionosphere | 34 | 0.114 | 0.109 ± 0.002 | [symbol] | 0.103 ± 0.008 |
| g50c | 50 | 0.255 | [symbol] | 0.092 ± 0.014 | 0.063 ± 0.048 |

TABLE 2

| | | Standard | | | |
|---|---|---|---|---|---|
| Dataset | n | SVM | ∇S3VM | CCCP-S3VM | MM-S3VM |
| Gaussian | 20 | 0.113 | 0.109 ± 0.001 | 0.110 ± 0.002 | [symbol] |
| Data | | | | | |
| Splice | 60 | 0.280 | 0.280 ± 0 | [symbol] | 0.245 ± 0.010 |
| a1a | 123 | 0.259 | 0.215 ± 0.001 | 0.255 ± 0.007 | [symbol] |
| fourclass | 2 | 0.208 | 0.208 ± 0.003 | 0.265 ± 0.001 | [symbol] |
| ionosphere | 34 | 0.028 | 0.025 ± 0.004 | 0.027 ± 0.017 | [symbol] |
| g50c | 50 | 0.100 | 0.082 ± 0.006 | 0.045 ± 0.009 | [symbol] |

5.4.1 Computation Time

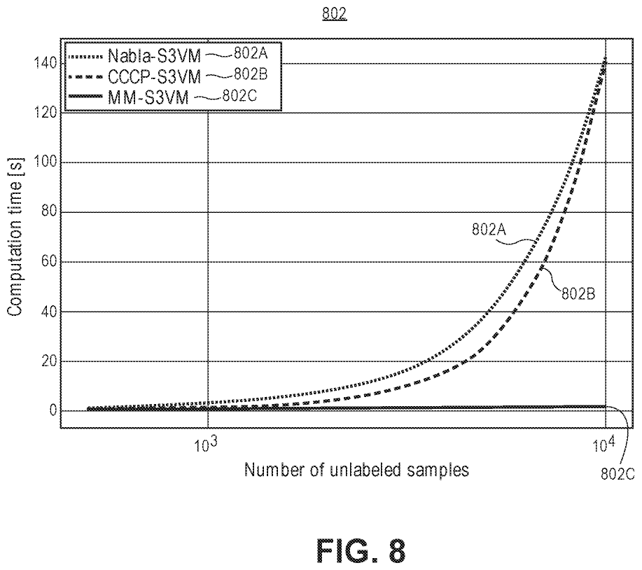

FIG. 8 shows a plot of optimization time versus a number of unlabeled examples for the three different algorithms, averaged over 20 trials, FIG. 8 includes a Nabla-S3VM 802A, a CCCP-S3VM 802B, a MM-S3VM 802C, an x-axis of “number of unlabeled samples,” and a y-axis of “computation time [s].” The unlabeled samples on the x-axis may be unlabeled data points in an unlabeled data set.

The Nabla-S3VM 802A may refer to the VS3VM algorithm. The Nabla-S3VM 802A has the longest computation time of the Nabla-S3VM 802a, the COOP-S3VM 802B, and the MM-S3VM 802C.

The CCCP-S3VM 802B has a slightly shorter computation time than the Nabla-S3VM 802A, particularly between 10³ and 10⁴ unlabeled samples. However, the CCCP-S3VM 802B has a longer computation time than the MM-S3VM 802C.

The MM-S3VM 802C has the shortest computation time compared to the Nabla-S3VM 802A and the CCCP-S3VM 802B. For example, at 10⁴ unlabeled samples the MM-S3VM 802C has a computation time of around a few seconds. The Nabla-S3VM 802A and the CCCP-S3VM 802B, at 10⁴ unlabeled samples, both have a computation time of around 140 seconds. Therefore, at 10⁴ unlabeled samples the MM-S3VM 802C is approximately at least 140 times faster than existing methods.

The MM-S3VM optimization time is near-constant computation time as the number of unlabeled examples increase. In other words, the computation time of the method (described above) is near-constant as the number of unlabeled data increases. Whereas the optimization time for both the ∇S3VM and the CCCP-S3VM increase quadratically as the number of unlabeled examples increase.

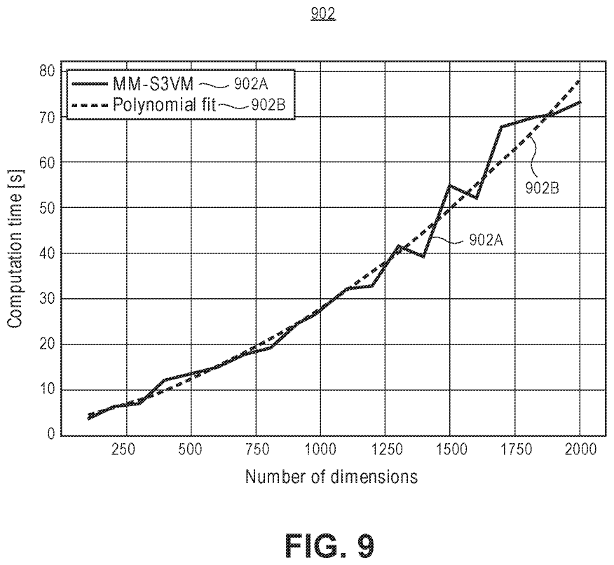

FIG. 9 plots the average computation time versus the number of dimensions, n, for the MM-S3VM. The data in FIG. 9 is averaged over 20 trials, and generated by synthetic Gaussian data, with L=100 and U=1000 The computation time increases polynomially with n. FIG. 9 includes a graph 902, MM-S3VM data 902A, a polynomial fit 902B, an x-axis of “number of dimensions,” and a y-axis of “computation time [s].” The MM-S3VM data 902A and the polynomial fit 902B are similar to one another. The MM-S3VM data 902A increases polynomially in computation time as the number of dimensions increases. In other words, the computation time of the method (described above) increases polynomially as number of dimensions increases.

### 6 Conclusion

Embodiments of the invention address the problem of finding the optimal classifier under a semi-supervised SVM framework and developed a heuristic for solving this problem. This was done using the MM algorithmic framework, implemented with a quadratic majorizer, and compared it against existing supervised and semi-supervised methods. In the experiments, the instant method is shown, in many cases, to achieve a smaller test error and a faster optimization time than the aforementioned existing methods. This shows that the MM-S3VM can compete and surpass state-of-the-art semi-supervised learning algorithms.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising:
a) obtaining, by a computing device, a data set comprising a subset of labeled data and a subset of unlabeled data;
b) determining, by the computing device, a minimization equation characterizing a semi-supervised learning process, the minimization equation comprising a convex component and a non-convex component;
c) applying, by the computing device, a smoothing function to the minimization equation to obtain a smoothed minimization equation;
d) determining, by the computing device, a surrogate function based on the smoothed minimization equation and the data set, wherein the surrogate function includes a convex surrogate function component and a non-convex surrogate function component;
e) performing a minimization process, by the computing device, on the surrogate function resulting in a temporary minimum solution;
f) repeating d) and e) until a global minimum solution is determined, the global minimum solution representing a maximum width between support vectors in a support vector machine; and
g) creating, by the computing device, the support vector machine using the global minimum solution.

2. The method of claim 1 further comprising:
comparing at least two temporary minimum solutions to determine if the global minimum solution is determined.

3. The method of claim 1, wherein the convex surrogate function component is comprised of convex terms of the minimization equation.

3. The method of claim 1, wherein the non-convex surrogate function component is determined by parameterizing non-convex terms of the minimization equation with a parameterization function, and applying a Taylor series expansion to the parameterization function.

5. The method of claim 1 further comprising:
applying additional unlabeled data to the support vector machine; and
applying additional labeled data to the support vector machine.

6. The method of claim 1 further comprising:
determining optimal hyperparameters.

7. The method of claim 1, wherein the data set relates to transaction data, disease data, image data, facial recognition data, action recognition data, text data, or sound data.

8. The method of claim 1, wherein computation time of the method is near-constant as the subset of unlabeled data increases from 10³ to 10⁴ unlabeled samples.

9. The method of claim 1, wherein computation time of the method increases polynomially as number of dimensions increase from 1 to 2000.

10. A computing device comprising:
a processor;
a memory device; and
a computer-readable medium coupled to the processor, the computer-readable medium comprising code executable by the processor for implementing a method comprising:
a) obtaining, by the computing device, a data set comprising a subset of labeled data and a subset of unlabeled data;
b) determining, by the computing device, a minimization equation characterizing a semi-supervised learning process, the minimization equation comprising a convex component and a non-convex component;
c) applying, by the computing device, a smoothing function to the minimization equation to obtain a smoothed minimization equation;
d) determining, by the computing device, a surrogate function based on the smoothed minimization equation and the data set, wherein the surrogate function includes a convex surrogate function component and a non-convex surrogate function component;
e) performing a minimization process, by the computing device, on the surrogate function resulting in a temporary minimum solution;
f) repeating d) and e) until a global minimum solution is determined, the global minimum solution representing a maximum width between support vectors in a support vector machine; and
g) creating, by the computing device, the support vector machine using the global minimum solution.

11. The computing device of claim 10, wherein the implemented method further comprises:
comparing at least two temporary minimum solutions to determine if the global minimum solution is determined.

12. The computing device of claim 10, wherein the convex surrogate function component is comprised of convex terms of the minimization equation.

13. The computing device of claim 10, wherein the non-convex surrogate function component is determined by parameterizing non-convex terms of the minimization equation with a parameterization function, and applying a Taylor series expansion to the parameterization function.

14. The computing device of claim 10, wherein the implemented method further comprises:
applying additional unlabeled data to the support vector machine; and
applying additional labeled data to the support vector machine.

15. The computing device of claim 10, wherein the implemented method further comprises:
determining optimal hyperparameters.

16. The computing device of claim 10, wherein the data set relates to transaction data, disease data, image data, facial recognition data, action recognition data, text data, or sound data.

17. The computing device of claim 10, wherein computation time of the method is near-constant as the subset of unlabeled data increases from 10³ to 10⁴ unlabeled samples.

18. The computing device of claim 10, wherein computation time of the method increases polynomially as number of dimensions increase from 1 to 2000.

19. A system comprising:
an input device comprising:
a first processor; and
a database storing a labeled data set and an unlabeled data set; and
a computing device comprising:
a second processor;
a memory device; and
a computer-readable medium coupled to the second processor, the computer-readable medium comprising code executable by the second processor for implementing a method comprising:
a) obtaining, by the computing device, a data set comprising a subset of labeled data and a subset of unlabeled data;
b) determining, by the computing device, a minimization equation characterizing a semi-supervised learning process, the minimization equation comprising a convex component and a non-convex component;
c) applying, by the computing device, a smoothing function to the minimization equation to obtain a smoothed minimization equation;
d) determining, by the computing device, a surrogate function based on the smoothed minimization equation and the data set, wherein the surrogate function includes a convex surrogate function component and a non-convex surrogate function component;
e) performing a minimization process, by the computing device, on the surrogate function resulting in a temporary minimum solution;
f) repeating d) and e) until a global minimum solution is determined, the global minimum solution representing a maximum width between support vectors in a support vector machine; and
g) creating, by the computing device, the support vector machine using the global minimum solution.

20. The system of claim 19, wherein the subset of labeled data is a subset of the labeled data set and the subset of unlabeled data is a subset of the unlabeled data set, wherein the computing device obtains the data set from the input device and provides the support vector machine to an output device, wherein the system further comprises:
the output device.
